(19) United States
(12) Patent Application Publication
(10) Pub. No.: US 2006/0122957 A1
(43) Pub. Date: Jun. 8, 2006

(54) Method and system to detect e-mail spam using concept categorization of linked content

(76) Inventor: Johnny Chen, Sunnyvale, CA (US)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 11/004,250

(22) Filed: Dec. 3, 2004

(51) Int. Cl. G06F 17/30

(52) U.S. Cl. 707/1

(57) ABSTRACT

A system and method for detecting undesired electronic messages (e.g., spam) using concept categorization of hyperlinks is disclosed. A server receives an electronic message and retrieves web pages that correspond to hyperlinks in the message. The server performs concept categorization on the retrieved web pages based on semantic relationships in the received information to determine whether the electronic message meets predefined criteria associated with undesired messages.

### RELATED APPLICATIONS

This application is related to U.S. patent application Ser. No. 10/676,571, filed Sep. 30, 2003, entitled “Method and Apparatus for Characterizing Documents Based on Clusters of Related Words,” which application is incorporated by reference herein in its entirety.

### TECHNICAL FIELD

The disclosed embodiments relate generally to electronic message filters. More particularly, the disclosed embodiments relate to methods and systems to detect undesired electronic messages using concept categorization of linked content.

### BACKGROUND

Every day, people send and receive millions of electronic messages, such as e-mail, over computer networks for business and leisure. Indeed, e-mail (also written as “email”) has become an extremely popular communication channel for people to exchange information.

Unfortunately, the e-mail that a computer user receives frequently includes spam, unsolicited bulk mailings, junk mail, or other undesired messages. Numerous techniques have been developed to try to detect and filter out such messages, with limited success. Thus, it would be highly desirable to more efficiently detect undesired electronic messages.

### SUMMARY

In one aspect of the invention, an electronic message is received. One or more hyperlinks in the electronic message are identified and information corresponding to at least one of the hyperlinks is received. At least part of the received information is categorized based on semantic relationships in the received information. Based at least in part on the categorization, whether the electronic message meets predefined criteria associated with undesired messages is determined.

### BRIEF DESCRIPTION OF THE DRAWINGS

For a better understanding of the aforementioned aspect of the invention as well as additional aspects and embodiments thereof, reference should be made to the Description of Embodiments below, in conjunction with the following drawings in which like reference numerals refer to corresponding parts throughout the figures.

FIG. 1 is a block diagram illustrating an exemplary distributed computer system according to an embodiment of the invention.

FIG. 2 is a block diagram illustrating message server 102 in accordance with one embodiment of the present invention.

FIG. 3 is a flowchart representing a method of detecting undesired electronic messages using concept categorization of linked content according to one embodiment.

### DESCRIPTION OF EMBODIMENTS

Methods and systems are described that show how to detect undesired electronic messages using concept categorization of linked content. Reference will be made to certain embodiments of the invention, examples of which are illustrated in the accompanying drawings. While the invention will be described in conjunction with the embodiments, it will be understood that it is not intended to limit the invention to these particular embodiments alone. On the contrary, the invention is intended to cover alternatives, modifications and equivalents that are within the spirit and scope of the invention as defined by the appended claims.

Moreover, in the following description, numerous specific details are set forth to provide a thorough understanding of the present invention. However, it will be apparent to one of ordinary skill in the art that the invention may be practiced without these particular details. In other instances, methods, procedures, components, and networks that are well-known to those of ordinary skill in the art are not described in detail to avoid obscuring aspects of the present invention.

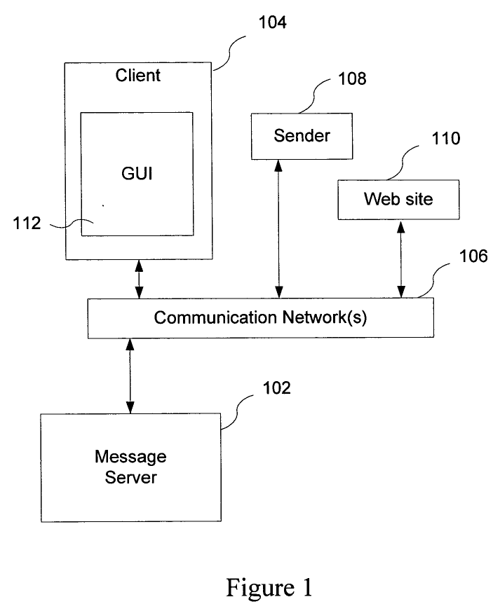

FIG. 1 is a block diagram illustrating an exemplary distributed computer system according to one embodiment of the invention. This system includes client computer 104, sender computer 108, web site 110, message server 102, and communication network(s) 106 for interconnecting these components. Client 104 includes graphical user interface (GUI) 112. Sender computer 108 sends one or more electronic messages (e.g., e-mail) to client 104 via communications network(s) 106 and server 102. Server 102 receives the electronic message and identifies one or more hyperlinks in the message to other URLs or network addresses, such as a URL or network address for web site 110. Server 102 requests and receives information (e.g., a web page or other content) corresponding to the URL or network address from web site 110 and categorizes the concepts in this information based on semantic relationships in the received information. Server 102 determines whether the message meets predefined criteria associated with undesired messages based at least in part on the categorization and filters the message accordingly. Client 104 receives filtered messages via communication network 106 from server 102. GUI 112 displays the messages.

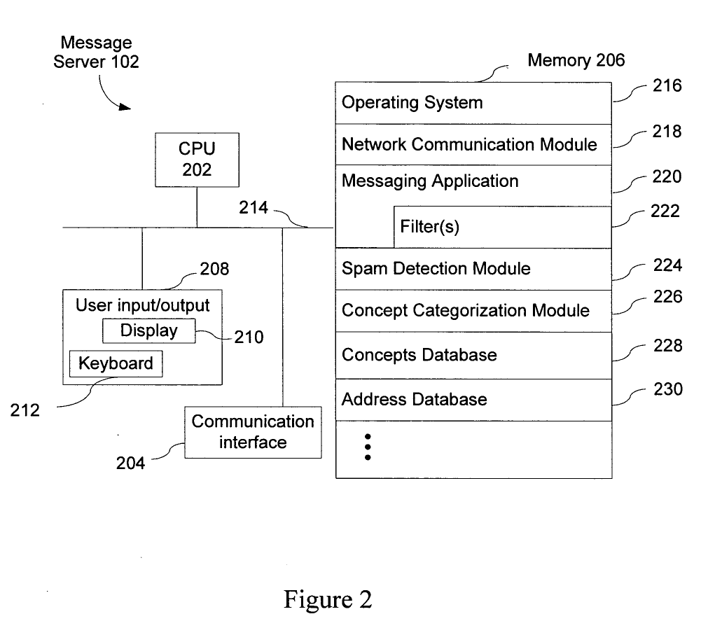

FIG. 2 is a block diagram illustrating message server 102 in accordance with one embodiment of the present invention. Server 102 typically includes one or more processing units (CPU's) 202, one or more network or other communications interfaces 204, memory 206, and one or more communication buses 214 for interconnecting these components. Server 102 optionally may include a user interface 208 comprising a display device 210 and a keyboard 212. Memory 206 may include high speed random access memory and may also include non-volatile memory, such as one or more magnetic disk storage devices. Memory 206 may optionally include one or more storage devices remotely located from the CPU(s) 202. In some embodiments, the memory 206 stores the following programs, modules and data structures, or a subset thereof:
an operating system 216 that includes procedures for handling various basic system services and for performing hardware dependent tasks;
a network communication module 218 that is used for connecting server 102 to other computers (e.g., sender 108 and client 104) via one or more communication network interfaces 204 (wired or wireless), such as the Internet, other wide area networks, local area networks, metropolitan area networks, and so on;
a messaging application 220 with one or more filters 222 that receives, filters, and distributes electronic messages (e.g., from sender 108 to client 104);
a spam detection module 224 that identifies hyperlinks in the messages, requests and receives information (e.g., web pages or files) corresponding to the hyperlinks, and determines whether the message meets predefined criteria associated with undesired messages based at least in part on concept categorization of the received information;
a concept categorization module 226 that categorizes at least part of the received information into concepts based on semantic relationships in the received information;
a concepts database 228 that stores concepts (also called clusters because the concepts can be used to generate related words); and
an address database 230 that stores the URLs and/or network addresses of web sites 110 and web pages that have previously been received and categorized, as well as the categorization results for these web sites and web pages.

Each of the above identified modules and applications corresponds to a set of instructions for performing a function described above. These modules (i.e., sets of instructions) need not be implemented as separate software programs, procedures or modules, and thus various subsets of these modules may be combined or otherwise re-arranged in various embodiments. In some embodiments, memory 206 may store a subset of the modules and data structures identified above. Furthermore, memory 206 may store additional modules and data structures not described above.

Although FIG. 2 shows server 102 as a number of discrete items, FIG. 2 is intended more as a functional description of the various features which may be present in server 102 rather than as a structural schematic of the embodiments described herein. In practice, and as recognized by those of ordinary skill in the art, items shown separately could be combined and some items could be separated. For example, some items shown separately in FIG. 2 could be implemented on single servers and single items could be implemented by one or more servers. The actual number of servers in server 102 and how features are allocated among them will vary from one implementation to another, and may depend in part on the amount of data traffic that the system must handle during peak usage periods as well as during average usage periods.

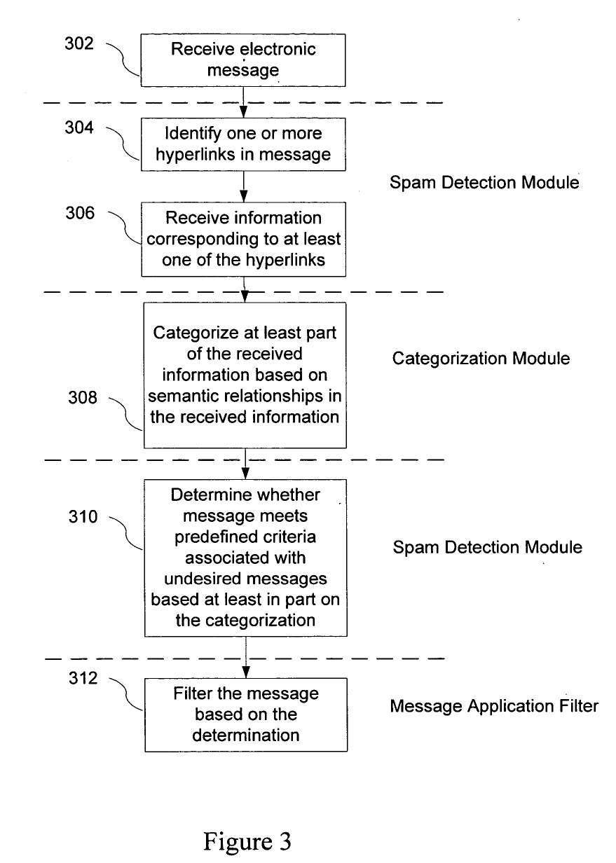

FIG. 3 is a flowchart representing a method of detecting undesired electronic messages using concept categorization of linked content according to one embodiment. The process shown in FIG. 3 is performed by message server 102 (FIG. 1). It will be appreciated by those of ordinary skill in the art that one or more of the acts described may be performed by hardware, software, or a combination thereof, as may be embodied in one or more computing systems. In other embodiments, an analogous process can be performed by client 104 using components analogous to those shown for server 102 in FIG. 2.

Messaging application 220 receives an electronic message (302) from sender 108 that is being sent to client 104. In some embodiments, the electronic message is an e-mail message.

Spam detection module 224 identifies one or more hyperlinks in the electronic message (304).

Spam detection module 224 sends a request for the web page, file, or other information corresponding to the hyperlink(s). A web site (e.g., 110) corresponding to the URL or network address in a given request receives the request and sends the corresponding information (i.e., the information stored at a location designated by the URL or network address) to server 102. In some embodiments, the corresponding information can be substantially all of the information stored at the web site.

Spam detection module 224 receives information corresponding to at least one of the hyperlinks in the electronic message (306). In some embodiments, the received information comprises a web page corresponding to one of the identified hyperlinks.

Categorization module 226 categorizes the concepts in at least part of the received information based on semantic relationships in the received information (308). In some embodiments, the categorizing is performed by determining a probability that a concept is part of the received information. In some embodiments, the categorizing is performed by determining respective probabilities that respective concepts are part of the received information and ranking the respective concepts according to those respective probabilities.

In some embodiments, a subset of conceptual categories, such as the ones with the highest scores in the received information, are associated with the received message.

Based at least in part on the concept categorization (308), spam detection module 224 determines whether the electronic message meets predefined criteria associated with undesired messages (310). In some embodiments, if the web page or other information has previously been received (306) and categorized (308) for a URL or network address, spam detection module 224 will use the information and/or categorization for that URL/network address that is stored in address database 230 to determine if the message is undesired.

In some embodiments, the categorizing associates a set of categories with the received information, and the determining is performed by generating a score, based on how well the categories match a predefined set of categories (e.g., categories associated with spam), and comparing the score with a threshold. In some embodiments, the categorizing associates a set of categories with the received information, and the determining includes determining whether any of the N highest ranked categories of the associated categories are included in a predefined set of undesired categories, where N is a predefined number (e.g., a number between 1 and 10). For example, if concepts database 228 includes the concepts (clusters) listed in FIG. 16 of U.S. patent application Ser. No. 10/676,571, the clusters “free sex porn pic movies xxx” and “nude naked pics pictures photos . . . ” may be predefined as undesirable categories. The categories associated with the received information can be compared to these two undesirable categories to determine how well the categories associated with the received information match the undesired categories. The comparison can be scored and compared to a threshold score. Alternatively, if any of the undesired concepts matches any of the N highest ranked categories in the received information, the message can be deemed to be undesirable.

In some embodiments, concept characterization is the sole basis for determining if the message is undesirable. For example, if the most probable concept contained in the received information, or in at least one part of the received information, is a concept previously categorized as undesirable, the message is deemed undesirable.

In other embodiments, concept characterization can be combined with other methods to determine if the message is undesirable in accordance with predefined criteria. These methods can examine other features in the message or the received information, such as the page layout (many spammers create new sites by copying one of their previously shut-down sites), the use of graphics, the existence of words like “buy now”, “enter here”, “porn” or “Viagra” that are disproportionate to spam sites, and/or the use of capitalized words.

In some embodiments, a message can be determined to be undesirable by looking at the domain registration information of the web sites associated with the hyperlinks in the message. This information can be determined by performing a who is lookup on the domain names that correspond to the hyperlinks. Domain name registration information of interest may include, without limitation, the contact and address information, and/or the expiration date of the domain name. Spammers typically register a site for just one year (the minimal duration permitted), so an expiration date corresponding to a one-year duration is often a sufficient criterion by itself to identify an undesired message.

In some embodiments, there may also be rules that permit messages received from a list of addresses (e.g., addresses to which the user has previously sent messages and/or addresses specified by the user) to not be considered undesirable, even if links in those messages are suspect.

In some embodiments, messaging application 220 includes one or more filters 222, which filter the message based on the determination of whether the electronic message meets predefined criteria associated with undesired messages (312). For messages that are determined to be undesirable, filtering can include not sending the message to client 104, deleting the message, flagging the message as undesirable, or sending the message to a folder labeled as “spam,” “junk mail,” “unsolicited mail,” or other similar name for undesirable messages. In some embodiments, the filtering can be done by another computer, such as client 104, rather than by server 102. Messages that are not determined to be undesirable are sent to client 104 (e.g., to an inbox in a messaging application at client 104).

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method, comprising:
a. receiving an e-mail message at a message server;
b. identifying one or more hyperlinks in the electronic message;
c. receiving a web page corresponding to one of the hyperlinks;
d. categorizing the received web page based on semantic relationships in the received web page; and
e. determining, based at least in part on the categorization of the received web page, whether the electronic message meets predefined criteria associated with undesired messages.

2. A method, comprising:
a. receiving an electronic message;
b. identifying one or more hyperlinks in the electronic message;
c. receiving information corresponding to at least one of the hyperlinks;
d. categorizing at least part of the received information based on semantic relationships in the received information; and
e. determining, based at least in part on the categorization of at least part of the received information, whether the electronic message meets predefined criteria associated with undesired messages.

3. The method of claim 2, wherein the electronic message is an e-mail message.

4. The method of claim 2, wherein the received information comprises a web page corresponding to one of the identified hyperlinks.

5. The method of claim 2, wherein the categorizing is performed by determining a probability that a concept is part of the received information.

6. The method of claim 2, wherein the categorizing is performed by determining respective probabilities that respective concepts are part of the received information.

7. The method of claim 6, wherein the categorizing includes ranking the respective concepts according to the respective probabilities that the respective concepts are present in the received information.

8. The method of claim 2, further comprising associating a subset of conceptual categories with the received message.

9. The method of claim 2, wherein the categorizing associates a set of categories with the received information, and the determining is performed by generating a score, associated with how well the associated categories match a predefined set of categories, and comparing the score with a threshold.

10. A system comprising at least one server, wherein said at least one server is configured to:
a. receive an electronic message;
b. identify one or more hyperlinks in the electronic message;
c. receive information corresponding to at least one of the hyperlinks;
d. categorize at least part of the received information based on semantic relationships in the received information; and
e. determine, based at least in part on the categorization of at least part of the received information, whether the electronic message meets predefined criteria associated with undesired messages.

11. A machine readable medium having stored thereon data representing sequences of instructions, which when executed by a computer, cause the computer to:
a. receive an electronic message;
b. identify one or more hyperlinks in the electronic message;
c. receive information corresponding to at least one of the hyperlinks;
d. categorize at least part of the received information based on semantic relationships in the received information; and
e. determine, based at least in part on the categorization of at least part of the received information, whether the electronic message meets predefined criteria associated with undesired messages.

12. A system, comprising:
a. means for receiving an electronic message;
b. means for identifying one or more hyperlinks in the electronic message;
c. means for receiving information corresponding to at least one of the hyperlinks;
d. means for categorizing at least part of the received information based on semantic relationships in the received information; and
e. means for determining, based at least in part on the categorization of at least part of the received information, whether the electronic message meets predefined criteria associated with undesired messages.

13. A method, comprising:
a. receiving an electronic message;
b. identifying one or more hyperlinks in the electronic message;
c. receiving domain name registration information for at least one of the hyperlinks that includes an expiration date of the domain name; and
d. determining, based at least in part on the expiration date of the domain name, whether the electronic message meets predefined criteria associated with undesired messages.
